(19) United States
(12) Patent Application Publication
(10) Pub. No.: US 2019/0118633 A1
(43) Pub. Date: Apr. 25, 2019

(54) Torque Strut Engine Motor Mount Protective Cover

(71) Applicant: Wen Chen, PARKLAND, FL (US)

(72) Inventor: Wen Chen, PARKLAND, FL (US)

(21) Appl. No.: 16/165,667

(22) Filed: Oct. 19, 2018

Related U.S. Application Data
(60) Provisional application No. 62/574,319, filed on Oct. 19, 2017.

(51) Int. Cl. B60K 5/12

(52) U.S. Cl. CPC B60K 5/1233; F16F 1/38; B60K 5/1241

(57) ABSTRACT

A torque strut engine motor mount protective cover includes an outer rubber bushing cover and an inner rubber bushing cover, wherein the outer and inner rubber bushing cover delineate a cup-shaped bodies. The outer and inner rubber bushing cover each includes a bolt fastening eyelet, a first elongated body, and a second elongated body. the bolt fastening eyelet traverses through a base plate of the inner rubber bushing cover and the outer rubber bushing cover. The first elongated body and the second elongated body that are terminally connected to the base plate so that the first and second elongated bodies can be inserted into the rubber bushing. Resultantly, the outer rubber bushing cover and the inner rubber bushing cover are concentrically mounted to each other and positioned offset from each other about the torque strut engine motor mount as a bolt is inserted through the bolt fastening eyelet.

The current application claims a priority to the U.S. Provisional Patent application Ser. No. 62/574,319 filed on Oct. 19, 2017.

### FIELD OF THE INVENTION

The present invention relates generally to a cover for a torque strut engine motor mount. More specifically, the present invention is a pair of covers that protect the rubber mount of the torque strut engine motor mount from heat, chemical contamination, and against other damaging forces that accelerate the normal wear and tear of the rubber mount.

### BACKGROUND OF THE INVENTION

A torque strut engine motor mount is utilized within a vehicle to stabilize the engine within the vehicle. However, a rubber bushing within the torque strut engine motor mount tends to structurally fail overtime due to many different causes. The first cause of failure is the effect of heat. More specifically, thermal degradation is highly complex, depending on the material exposed and the contact media. There is no single diagnostic effect, nor visible externally when internal heat buildup causes thermal degradation for the rubber bushing. As the temperature increases, the rate of reaction of rubber degradation processes also increases. Excessive exposure to heat leads a deterioration in material properties and ultimately chemical degradation of polymer itself thus structurally weakening the torque strut engine motor mount. The second cause is the chemical contamination. More specifically, engine oil, power steering fluid, transmission fluid, gasoline, diesel, brake fluid, and other engine related chemical contamination can degrade rubber bushing. The severity and effect depends on the chemical and the chemistry of the rubber being damaged, wherein deterioration of the rubber bushing structurally weaken the torque strut engine motor mount. The third cause is product design. More specifically, poorly engineered rubber bushing tend to fail easily and quickly thus structurally weakening the torque strut engine motor mount. Lastly, choosing the incorrect material mixture and process. More specifically, having the incorrect material mixture and manufacturing process can limit the product life cycle of the rubber bushing thus structurally weakening the torque strut engine motor mount.

It is an objective of the present invention to provide a torque strut engine motor mount protective cover. More specifically, the present invention is a protective cover that encloses the rubber bushing of the torque strut engine motor mount. Due to the fact the present invention is able to enclose the rubber bushing, the present invention is able to keep out heat, dust, and chemicals away from the rubber bushing. As a result, the present invention is able to improve the reliability of the rubber bushing thus extending the life cycle of the torque strut engine motor mount.

### BRIEF DESCRIPTION OF THE DRAWINGS

FIG. 1 is a perspective view of the present invention utilized with the torque strut engine motor mount.

FIG. 2 is an exploded view of the present invention utilized with the torque strut engine motor mount.

FIG. 3 is an outer perspective view of the outer rubber bushing cover of the present invention.

FIG. 4 is an inner perspective view of the outer rubber bushing cover of the present invention.

FIG. 5 is an outer perspective view of the inner rubber bushing cover of the present invention.

FIG. 6 is an inner perspective view of the inner rubber bushing cover of the present invention.

FIG. 7 is a side view of the outer or inner rubber bushing cover of the present invention, showing the diametrical positioning of the first elongated body and the second elongated body.

FIG. 8 is a side view of the outer or inner rubber bushing cover of the present invention, showing the offset positioning of the free end of the first elongated body and the second elongated body and the rim.

### DETAIL DESCRIPTIONS OF THE INVENTION

All illustrations of the drawings are for the purpose of describing selected versions of the present invention and are not intended to limit the scope of the present invention.

A rubber bushing of the torque strut engine motor mount, generally placed within a strut eyelet of the torque strut engine motor mount, often fails due to heat, dust, and chemical contamination thus weakening the structural integrity of the torque strut engine motor mount. Over exposure to these factors accelerates the rubber degradation and deterioration of the rubber bushing itself. The present invention is a torque strut engine motor mount protective cover that insulates and protects the rubber bushing against damaging forces that accelerates the normal wear and tear. The present invention's design is a precise fit providing extra support to the rubber bushing, reinforcing the torque strut engine motor mount against vibration caused by engine acceleration and braking, and protecting the strut eyelet of the torque strut engine motor mount with its sealed technology that prevents exposure to damaging factors.

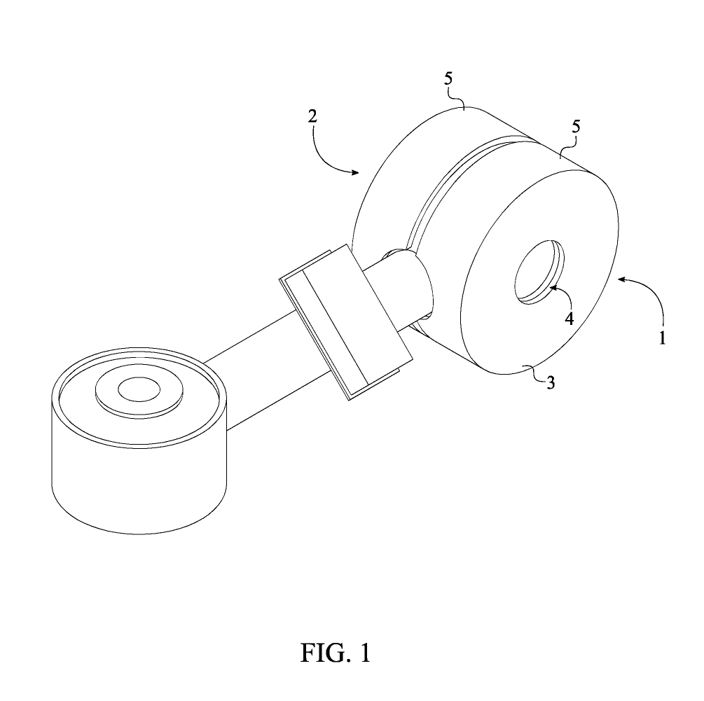

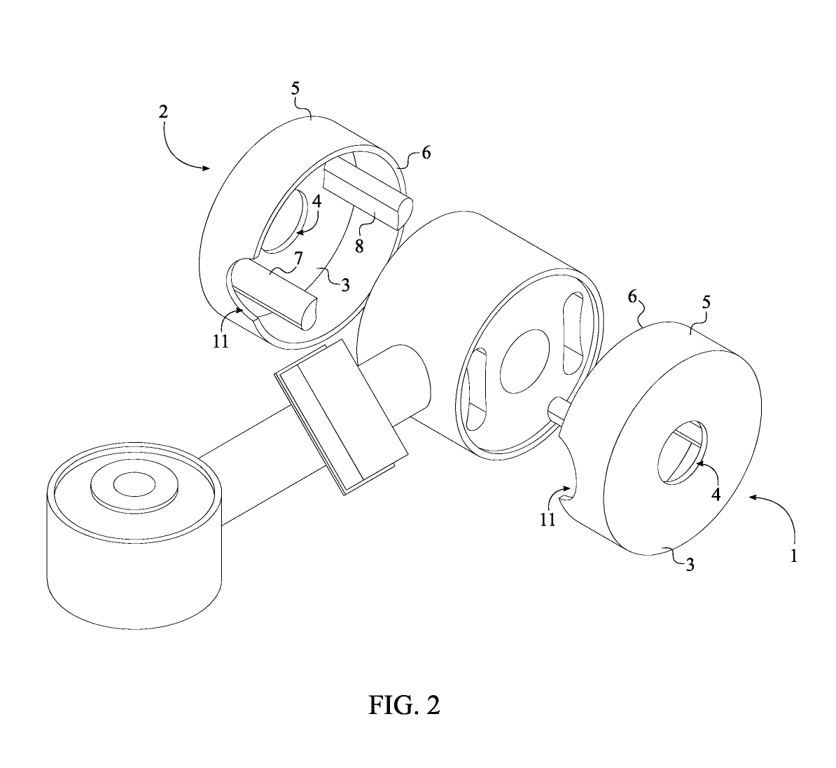

The present invention comprises an outer rubber bushing cover 1 and an inner rubber bushing cover 2 as shown in FIG. 1-2. The outer rubber bushing cover 1 and the inner rubber bushing cover 2 delineate a cup-shaped bodies within the present invention so that the outer rubber bushing cover 1 and the inner rubber bushing cover 2 are able to conceal the rubber bushing. More specifically, the outer rubber bushing cover 1 and the inner rubber bushing cover 2 are positioned offset from each other and concentrically mounted to each other by a bolt that secures the torque strut engine motor mount to the engine block.

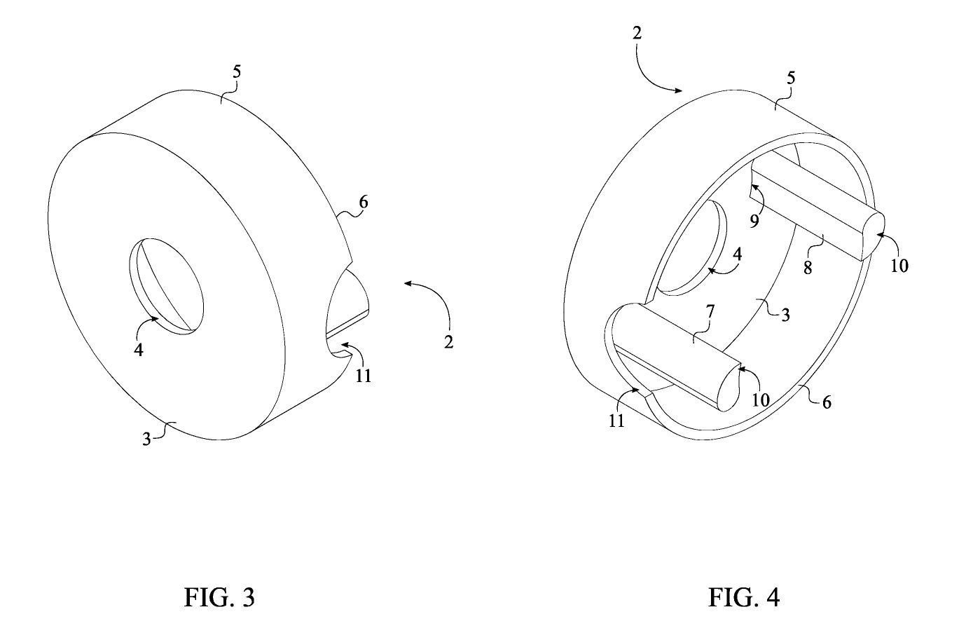

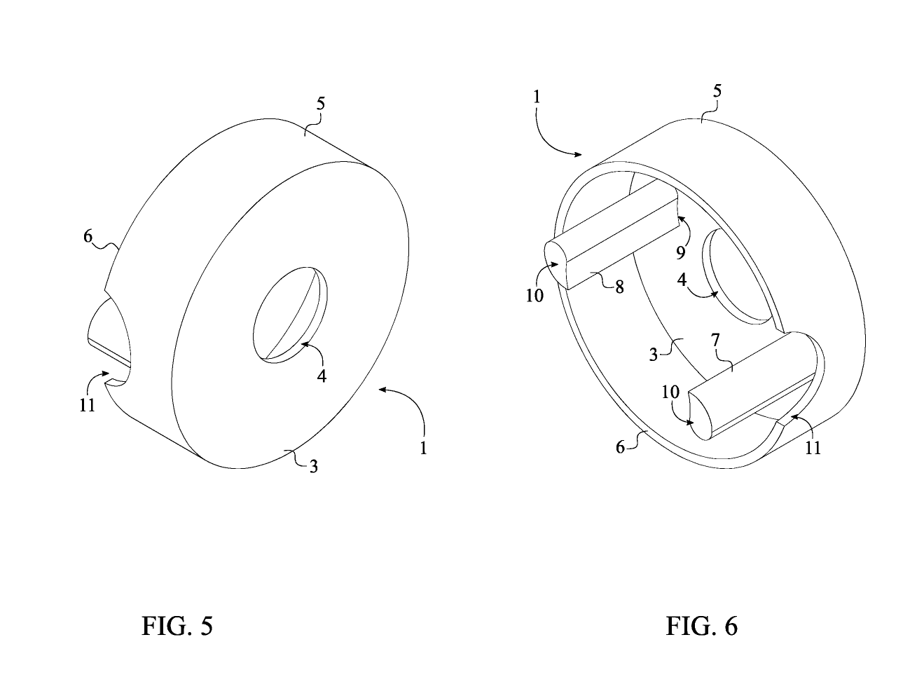

In reference to FIG. 3-6, the outer rubber bushing cover 1 and the inner rubber bushing cover 2 each comprises a base plate 3, a lateral wall 5, a bolt fastening eyelet 4, a first elongated body 7, a second elongated body 8, and an arm receiving cutout 11. In order to delineate the cup-shaped profile for the outer rubber bushing cover 1 and the inner rubber bushing cover 2, the lateral wall 5 is perimetrically connected around the base plate 3. Furthermore, a rim 6 of the lateral wall 5 is oppositely positioned of the base plate 3 as the rim 6 is circumferentially positioned around the lateral wall 5. The inner diameter of the outer rubber bushing cover 1 and the inner rubber bushing cover 2 is larger than the strut eyelet of the torque strut engine motor mount so that the rubber bushing can be fully enclosed within the outer rubber bushing cover 1 and the inner rubber bushing cover 2. In order to properly place the outer rubber bushing cover 1 and the inner rubber bushing cover 2, the arm receiving cutout 11 is positioned on the lateral wall 5. More specifically, the arm receiving cut out traverses into the lateral wall 5 from the rim 6 to accommodate a shaft of the torque strut engine motor mount, wherein the shaft of the torque strut engine motor mount connects the strut eyelet of the torque strut engine motor mount to the frame of the vehicle. The preferred shape of the arm receiving cutout 11 can differ within the present invention as the preferred shape of the arm receiving cutout 11 is determined upon the cross-sectional shape of the shaft of the torque strut engine motor mount. For example, when the shaft of the torque strut engine motor mount is circular, the arm receiving cutout 11 is preferably shaped into a semi-circular profile so that the outer rubber bushing cover 1 and the inner rubber bushing cover 2 can be tightly placed around the strut eyelet of the torque strut engine motor mount.

In reference to FIG. 3-6, the bolt fastening eyelet 4 traverses through the base plate 3 so that the outer rubber bushing cover 1 and the inner rubber bushing cover 2 are able to provide an opening for the insertion of the bolt. More specifically, the bolt fastening eyelet 4 concentrically positioned to the base plate 3 and positioned in between the first elongated body 7 and the second elongated body 8. The diameter of the bolt fastening is determined upon the diameter of the bolt so that the bolt can be easily inserted through the bolt fastening eyelet 4 and the rubber bushing.

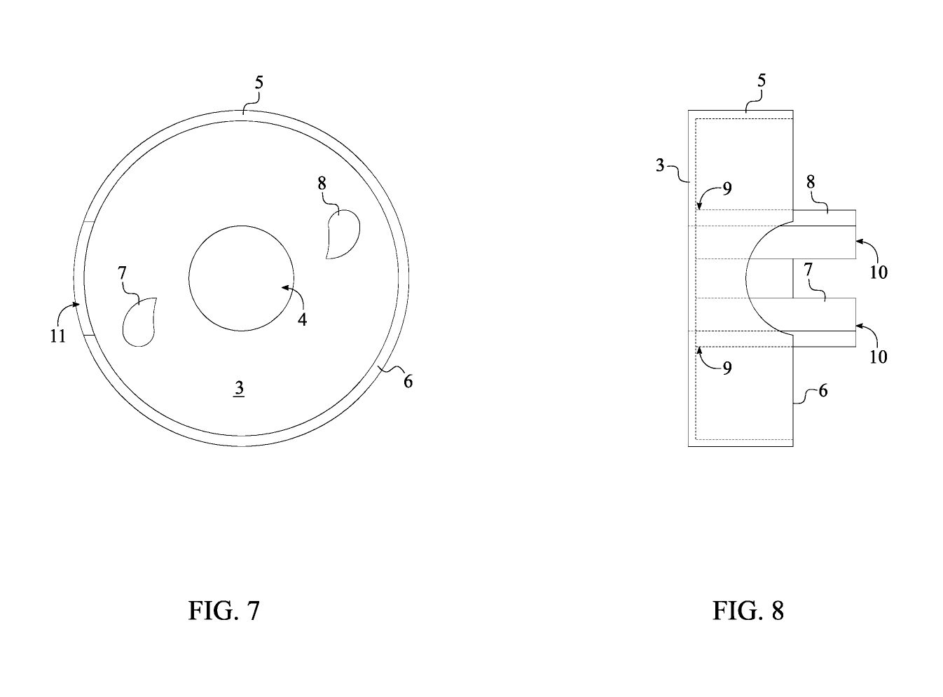

The first elongated body 7 and the second elongated body 8 function as retaining members and reinforcing members within the present invention as the first elongated body 7 and the second elongated body 8 collectively maintain the opposite positioning of the outer rubber bushing cover 1 and the inner rubber bushing cover 2. In reference to FIG. 7, the first elongated body 7 and the second elongated body 8 are positioned within the lateral wall 5 and diametrically opposed of each other. The first elongated body 7 is terminally connected to the base plate 3 and extends pass the rim 6. Similarly, the second elongated body 8 is terminally connected to the base plate 3 and extends pass the rim 6. More specifically, the first elongated body 7 and the second elongated body 8 each comprises a fixed end 9 and a free end 10 as shown in FIG. 8. The fixed end 9 is terminally connected and positioned normal to the base plate 3 thus resulting the free end 10 to be positioned offset from the rim 6. Due to the extended shape of the first elongated body 7 and the second elongated body 8, the first elongated body 7 and the second elongated body 8 can be inserted into an existing opening of the rubber bushing so that the outer rubber bushing cover 1 and the inner rubber bushing cover 2 can be friction-fitted to the rubber bushing. Resultantly, the first elongated body 7 and the second elongated body 8 are able to improve the structural integrity of the rubber bushing while functioning as the retaining members.

The first elongated body 7 and the second elongated body 8 also function as flexible bodies within the present invention. As a result, the first elongated body 7 and the second elongated body 8 are able to compensate the engine vibration. More specifically, the flexibility of the first elongated body 7 and the second elongated body 8 allow the rubber bushing to move back and forth during in vehicle acceleration and braking.

When the outer rubber bushing cover 1 is utilized with the torque strut engine motor mount, the first elongated body 7 and the second elongated body 8 of the outer rubber bushing cover 1 are oriented towards the base plate 3 of the inner rubber bushing cover 2. When the inner rubber bushing cover 2 is utilized with the torque strut engine motor mount, the first elongated body 7 and the second elongated body 8 of the inner rubber bushing cover 2 are oriented towards the base plate 3 of the outer rubber bushing cover 1. Resultantly, the first elongated body 7 and the second elongated body 8 are able to reinforce and secures the base plate 3 and the lateral wall 5 with respect to the corresponding bushing cover. The base plate 3 of the outer rubber bushing cover 1 and the base plate 3 of the inner rubber bushing cover 2 are positioned offset from each other as the lateral wall 5 of the outer rubber bushing cover 1 and the inner rubber bushing cover 2 partially cover the strut eyelet of the torque strut engine motor mount. Resultantly, the base plate 3 and the lateral wall 5 are collectively able to protect the rubber bushing with respect to the corresponding bushing cover. The bolt fastening eyelet 4 of the outer rubber bushing cover 1 and the bolt fastening eyelet 4 of the inner rubber bushing cover 2 are concentrically mounted to each other through the bolt that secures the torque strut engine motor mount to the engine block.

Although the invention has been explained in relation to its preferred embodiment, it is to be understood that many other possible modifications and variations can be made without departing from the spirit and scope of the invention as hereinafter claimed.

What is claimed is:

1. A torque strut engine motor mount protective cover comprises:
an outer rubber bushing cover;
an inner rubber bushing cover;
the outer rubber bushing cover and the inner rubber bushing cover each comprises a base plate, a lateral wall, a bolt fastening eyelet, a first elongated body, and a second elongated body;
the lateral wall being perimetrically connected around the base plate;
the bolt fastening eyelet traversing through the base plate;
the first elongated body and the second elongated body being positioned within the lateral wall;
the first elongated body being terminally connected to the base plate;
the second elongated body being terminally connected to the base plate;
the first elongated body and the second elongated body of the outer rubber bushing cover being oriented towards the base plate of the inner rubber bushing cover;
the first elongated body and the second elongated body of the inner rubber bushing cover being oriented towards the base plate of the outer rubber bushing cover;
the base plate of the outer rubber bushing cover and the base plate of the inner rubber bushing cover being positioned offset from each other; and
the bolt fastening eyelet of the outer rubber bushing cover and the bolt fastening eyelet of the inner rubber bushing cover being concentrically mounted to each other.

2. The torque strut engine motor mount protective cover as claimed in claim 1 comprises:
the outer rubber bushing cover and the inner rubber bushing cover each comprises an arm receiving cutout;
a rim of the lateral wall being oppositely positioned of the base plate;
the rim being circumferentially positioned around the lateral wall; and
the arm receiving cutout traversing into the lateral wall from the rim.

3. The torque strut engine motor mount protective cover as claimed in claim 1, wherein the first elongated body and the second elongated body being diametrically opposed of each other.

4. The torque strut engine motor mount protective cover as claimed in claim 1 comprises:
the first elongated body and the second elongated body each comprises a fixed end and a free end;
the fixed end being terminally connected and normal to the base plate; and
the free end being positioned offset from a rim of the lateral wall.

5. The torque strut engine motor mount protective cover as claimed in claim 1, wherein the first elongated body is a flexible body.

6. The torque strut engine motor mount protective cover as claimed in claim 1, wherein the second elongated body is a flexible body.

7. The torque strut engine motor mount protective cover as claimed in claim 1 comprises:
the bolt fastening eyelet being positioned in between the first elongated body and the second elongated body; and
the bolt fastening eyelet being concentrically positioned to the base plate.

8. A torque strut engine motor mount protective cover comprises:
an outer rubber bushing cover;
an inner rubber bushing cover;
the outer rubber bushing cover and the inner rubber bushing cover each comprises a base plate, a lateral wall, a bolt fastening eyelet, a first elongated body, and a second elongated body;
the lateral wall being perimetrically connected around the base plate;
the bolt fastening eyelet traversing through the base plate;
the first elongated body and the second elongated body being positioned within the lateral wall;
the first elongated body being terminally connected to the base plate;
the second elongated body being terminally connected to the base plate;
the bolt fastening eyelet being positioned in between the first elongated body and the second elongated body;
the bolt fastening eyelet being concentrically positioned to the base plate;
the first elongated body and the second elongated body of the outer rubber bushing cover being oriented towards the base plate of the inner rubber bushing cover;
the first elongated body and the second elongated body of the inner rubber bushing cover being oriented towards the base plate of the outer rubber bushing cover;
the base plate of the outer rubber bushing cover and the base plate of the inner rubber bushing cover being positioned offset from each other; and
the bolt fastening eyelet of the outer rubber bushing cover and the bolt fastening eyelet of the inner rubber bushing cover being concentrically mounted to each other.

9. The torque strut engine motor mount protective cover as claimed in claim 8 comprises:
the outer rubber bushing cover and the inner rubber bushing cover each comprises an arm receiving cutout;
a rim of the lateral wall being oppositely positioned of the base plate;
the rim being circumferentially positioned around the lateral wall; and
the arm receiving cutout traversing into the lateral wall from the rim.

10. The torque strut engine motor mount protective cover as claimed in claim 8, wherein the first elongated body and the second elongated body being diametrically opposed of each other.

11. The torque strut engine motor mount protective cover as claimed in claim 8 comprises:
the first elongated body and the second elongated body each comprises a fixed end and a free end;
the fixed end being terminally connected and normal to the base plate; and
the free end being positioned offset from a rim of the lateral wall.

12. The torque strut engine motor mount protective cover as claimed in claim 8, wherein the first elongated body is a flexible body.

13. The torque strut engine motor mount protective cover as claimed in claim 8, wherein the second elongated body is a flexible body.

14. A torque strut engine motor mount protective cover comprises:
an outer rubber bushing cover;
an inner rubber bushing cover;
the outer rubber bushing cover and the inner rubber bushing cover each comprises a base plate, a lateral wall, a bolt fastening eyelet, a first elongated body, and a second elongated body;
the lateral wall being perimetrically connected around the base plate;
the bolt fastening eyelet traversing through the base plate;
the first elongated body and the second elongated body being positioned within the lateral wall;
the first elongated body being terminally connected to the base plate;
the second elongated body being terminally connected to the base plate;
the first elongated body and the second elongated body being diametrically opposed of each other;
the bolt fastening eyelet being positioned in between the first elongated body and the second elongated body;
the bolt fastening eyelet being concentrically positioned to the base plate;
the first elongated body and the second elongated body of the outer rubber bushing cover being oriented towards the base plate of the inner rubber bushing cover;
the first elongated body and the second elongated body of the inner rubber bushing cover being oriented towards the base plate of the outer rubber bushing cover;
the base plate of the outer rubber bushing cover and the base plate of the inner rubber bushing cover being positioned offset from each other; and
the bolt fastening eyelet of the outer rubber bushing cover and the bolt fastening eyelet of the inner rubber bushing cover being concentrically mounted to each other.

15. The torque strut engine motor mount protective cover as claimed in claim 14 comprises:
the outer rubber bushing cover and the inner rubber bushing cover each comprises an arm receiving cutout;
a rim of the lateral wall being oppositely positioned of the base plate;
the rim being circumferentially positioned around the lateral wall; and
the arm receiving cutout traversing into the lateral wall from the rim.

16. The torque strut engine motor mount protective cover as claimed in claim 14 comprises:
the first elongated body and the second elongated body each comprises a fixed end and a free end;
the fixed end being terminally connected and normal to the base plate; and
the free end being positioned offset from a rim of the lateral wall.

17. The torque strut engine motor mount protective cover as claimed in claim 14, wherein the first elongated body is a flexible body.

18. The torque strut engine motor mount protective cover as claimed in claim 14, wherein the second elongated body is a flexible body.
